(19) United States
(12) Patent Application Publication
(10) Pub. No.: US 2005/0272586 A1
(43) Pub. Date: Dec. 8, 2005

(54) Gripper for a web folding cylinder

(76) Inventors: Patrick C. St. Germain, Iron River, WI (US); Vernon C. Wickman, Port Wing, WI (US)

Correspondence Address: OLSON & HIERL, LTD., 36th Floor, 20 North Wacker Drive, Chicago, IL, 60606, US

(21) Appl. No.: 10/861,057

(22) Filed: Jun. 4, 2004

(51) Int. Cl. B31F 1/08

(52) U.S. Cl. 493/428

(57) ABSTRACT

The present invention provides an improved gripper for a folding cylinder of a folding machine. Each gripper is independently actuated and includes a gripper member and cam follower arm having their own springs to provide a gripping force and to allow it to operate separately from other gripper members on the same folding cylinder. The force to open the gripper prior to the material to be folded being tucked into the folding cylinder opening is generated by the involute profile on the cam arm which pushes against the involute profile on each gripper member. Independently actuated grippers provide the advantage that the folding operation is not susceptible to material thickness variations and it is possible to fold materials with a different thickness on different lanes of a web folding machine.

### FIELD OF THE INVENTION

The present invention relates to cam-driven, independently actuated grippers for the folding cylinders of a web folding machine.

### BACKGROUND OF THE INVENTION

Web folding machines typically use a pair of folding cylinders to perform folding operations on the web material processed thereby. Such folding cylinders can process several feeds of web material simultaneously, with the feeds following respective parallel lanes or pathways across the width of the cylinders. As the webs are fed between the cylinder pair, tucking and gripping mechanisms located on the respective surfaces of each cylinder co-act with one another to tuck and grip the webs to create one or more folds therein. With the tuck and grip folding method, as a given web is deposited between the pair of folding cylinders, a pointed tucker blade located on the surface of one of the cylinders pushes or tucks the material into a space existing between the open jaws of a gripper located on the surface of the opposite cylinder. The open gripper jaws then close on the web to create the fold or crease in the web material itself.

The gripper jaws of present web folding machines typically comprise a fixed jaw defined in the surface of a folding cylinder and a co-acting, moving gripper jaw movably attached to the same cylinder. These moving gripper jaws are cam-driven to an opened position and spring-biased to a closed position. With such an arrangement, the folding cylinder and cam are typically mounted to the frame of the machine, with the cam located within the interior of the folding cylinder.

Present mechanical folding machines using the tuck and grip folding method to process multiples lanes of web material typically place the movable cam arms of the grippers for each lane along a common shaft running the full width of the folding cylinder. The gripping force provided by the coil spring against the cam arm for each gripper are thus shared by the multiple lanes of web material across a folding cylinder because each cam arm is connected to the common shaft. However, if the thickness of web material in one lane of the folding cylinder is greater than the thickness of web material in a different lane, the lane with the thickest web material will receive all of the gripping force and not allow the grippers in the other lanes to close far enough to hold the material therein. When the material in the other lane is not gripped properly by the gripping jaws, the web is pulled out of the respective grippers, resulting in a material jam during folding operations. Thus, the gripper actuation mechanisms of present folding machines suffer the disadvantage of having the inability to simultaneously process web materials of different thicknesses without the occurrence of jamming.

Thus, there is a need for an apparatus and method that overcomes the disadvantages of an increased wear of the cam and follower due to an increased thickness of the web material gripped within the grippers and the disadvantages of having the inability to simultaneously process web materials of different thicknesses without the occurrence of jamming.

### SUMMARY OF THE INVENTION

The present invention provides an improved gripper for a folding cylinder of a folding machine. Each gripper has a gripper member independently actuated and with its own bearing so as to allow it to operate separately from other gripper members on the same folding cylinder. Each gripper also has its own set of springs to provide a gripping force. The force to open the gripper prior to the material to be folded being tucked into the folding cylinder opening is generated by an involute profile on the cam arm which pushes against an involute profile on each gripper member. The cam follower arm also has its own spring which is used to hold the cam arm roller tightly against the cam. Independently actuated grippers provide the advantage that the folding operation is no longer susceptible to material thickness variations. It is also possible to fold materials with a different thickness on different lanes of a web folding machine.

### BRIEF DESCRIPTION OF THE DRAWINGS

In the drawings:

FIG. 1 is a side sectional view of a portion of a folding cylinder with one embodiment of the cam-driven gripper of the present invention having the gripper jaws in the closed position;

FIG. 2 is a side sectional view of the cylinder portion with the cam-driven gripper actuation mechanism of FIG. 1 having the gripper jaws in the open position; and

FIG. 3 is a side sectional view cylinder portion with the cam-driven gripper actuation mechanism of FIG. 1 having a web material of increased thickness received within the gripper jaws.

### DESCRIPTION OF THE PREFERRED EMBODIMENTS

The invention disclosed herein is, of course, susceptible of embodiment in many different forms. Shown in the drawings and described herein below in detail are preferred embodiments of the invention. It is understood, however, that the present disclosure is an exemplification of the principles of the invention and does not limit the invention to the illustrated embodiments. For ease of description, a web folding machine gripper actuating mechanism embodying the present invention is described herein below in its usual assembled position as shown in the accompanying drawings, and terms such as upper, lower, horizontal, longitudinal, etc., may be used herein with reference to this usual position. However, the actuating mechanism may be manufactured, transported, sold, or used in orientations other than that described and shown herein.

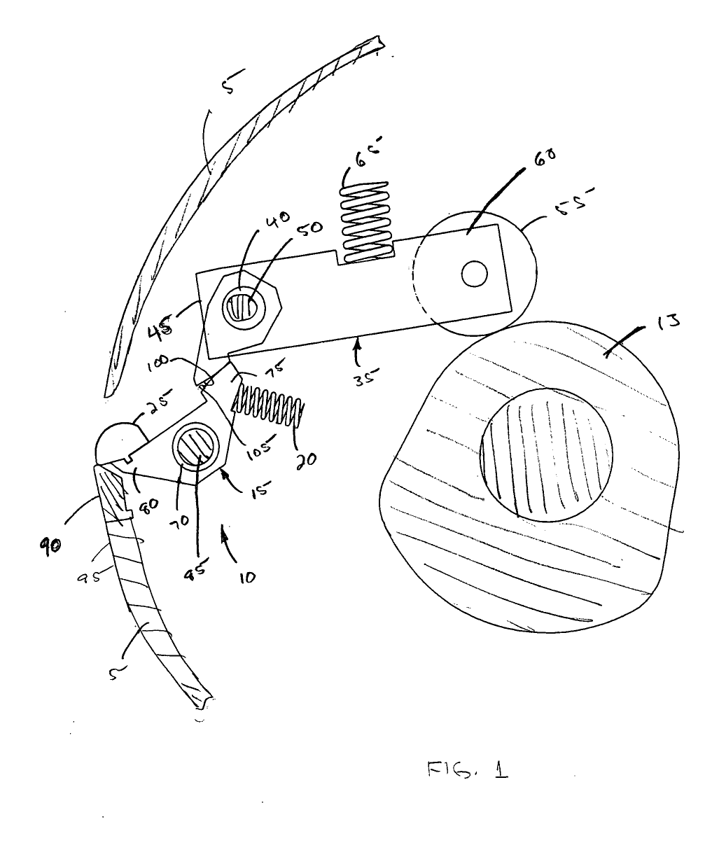

The present invention provides an improved gripper for a folding cylinder of a folding machine. FIG. 1 is a side sectional view of a portion of a folding cylinder 5 having gripper 10 located within its interior. The folding cylinder and gripper 10 rotate around fixed cam 13. Gripper 10 includes a gripper member 15 that is independently actuated and has its own bearing so as to allow it to operate separately from other gripper members located on the same folding cylinder. The gripper member 15 also has its own spring 20 to provide a gripping force. The force of the cam 13 to open the movable gripper jaw 25, prior to the material to be folded being tucked into the folding cylinder opening 30, is translated through the involute profile of the cam follower arm 35 and through the involute profile of the gripper member 15. The independently actuated gripper member 15 provides the advantage that the folding operation is no longer susceptible to material thickness variations and allows a folding cylinder to fold materials with a different thickness on different lanes of a web folding machine.

Gripper 10 comprises a cam follower arm 35 rotatably connected to the folding cylinder 5. In one embodiment, the cam follower arm 35 may be connected to a common shaft having other cam follower arms mounted thereto, with the shaft being rotatably mounted to the folding cylinder 5 via one or more bearings. In the preferred embodiment of the invention, the cam follower arm 35 is rotatably mounted to the folding cylinder 5 by an arm bearing 40 located proximal to the arm's first end 45. The arm bearing 40 allows the arm to pivot about the arm pin 50, which is preferably attached to the folding cylinder 5 within the interior of the folding cylinder.

The cam follower arm 35 is operably connected to a cam follower 55 located at its second end 60. Although the cam follower 55 comprises a roller, it is understood that the cam follower 55 may also comprise a skid, pin or any other follower understood in the art as capable of operational engagement with a cam. The cam follower arm second end 60 is spring-biased towards the fixed cam 13 by the arm spring 65. Thus, as the folding cylinder 5 and gripper 10 rotate about the fixed cam 13, the arm spring 65 urges the cam follower 55 against the cam 13.

The gripper member 15 is rotatably connected to the folding cylinder 5, independent of other gripper members, by a bearing 70 located between the member's first and second ends 75 and 80. The bearing 70 allows the gripper member 15 to pivot about a member pin 85, which is preferably attached to the folding cylinder 5 within the cylinder's interior. The gripper member first end 75 is operably associated with the cam follower arm first end 45 while the second end 80 defines a movable jaw 25 for operable association with a fixed jaw or anvil 90, located proximal to an outer surface 95 of the folding cylinder 5. The gripper member first end 75 is spring-biased towards the cam follower arm 35 by a member spring 20 located at the member's first end 75.

Cam follower arm 35 and gripper member 15 each define an involute profile between their respective first and second ends. The involute profiles respectively defined by the cam follower arm 35 and the gripper member 15 are positioned to facilitate the operable association between their respective first ends 45 and 75. The cam follower arm first end 45 and the gripper member first end 75 define respective contact surfaces 100 and 105. Because the involute profiles of cam follower arm 35 and the gripper member 15 are in apposition to one another, the arm contact surface 100 and member contact surface 105 are also in apposition to one another.

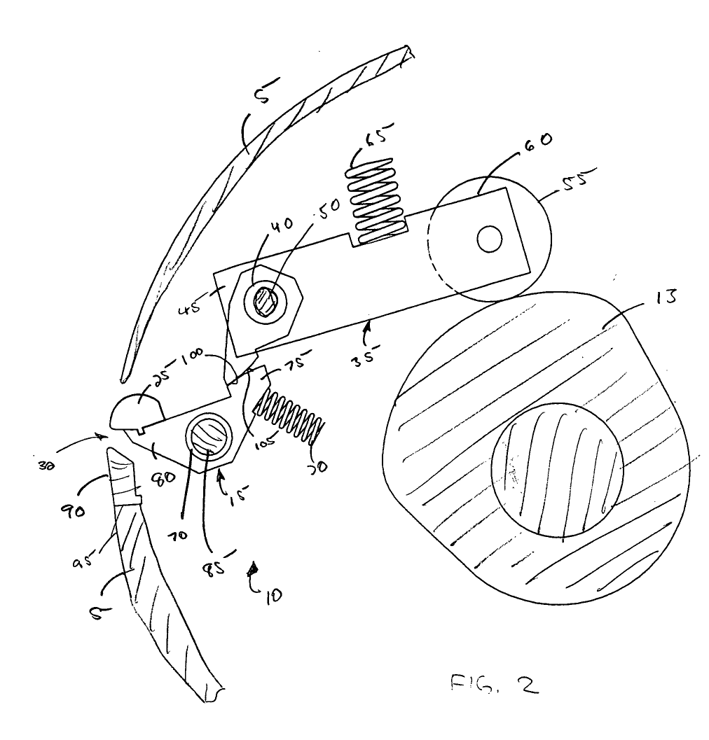

Turning to FIG. 2, the gripper member contact surface 105 is urged against the cam follower arm contact surface 100 by the member spring 20 while the cam follower 55 located at the second end 60 of the cam follower arm 35 is urged against the rotating cam 13 by the arm spring 65. Thus, as the folding cylinder 5 and gripper 10 rotate about the fixed cam 13, the extended profile of the cam surface exerts a force against the cam follower 55. The force against the follower 55 causes the follower arm 35 to pivot about arm pin 50, translating the force to the cam follower arm contact surface 100 located at the arm's first end 45.

The force of the arm contact surface 100 is then transferred to the gripper member contact surface 105, which is urged against the cam follower arm contact surface 100 by the member spring 20 located at the member's first end 75. The force of the cam follower arm contact surface 100 against the gripper member contact surface 105 causes the gripper member 15 to pivot about member pin 85, thus urging the movable jaw 25 of the gripper member away from the fixed jaw 90 of the folding cylinder 5 to release any folded product held between the two jaws.

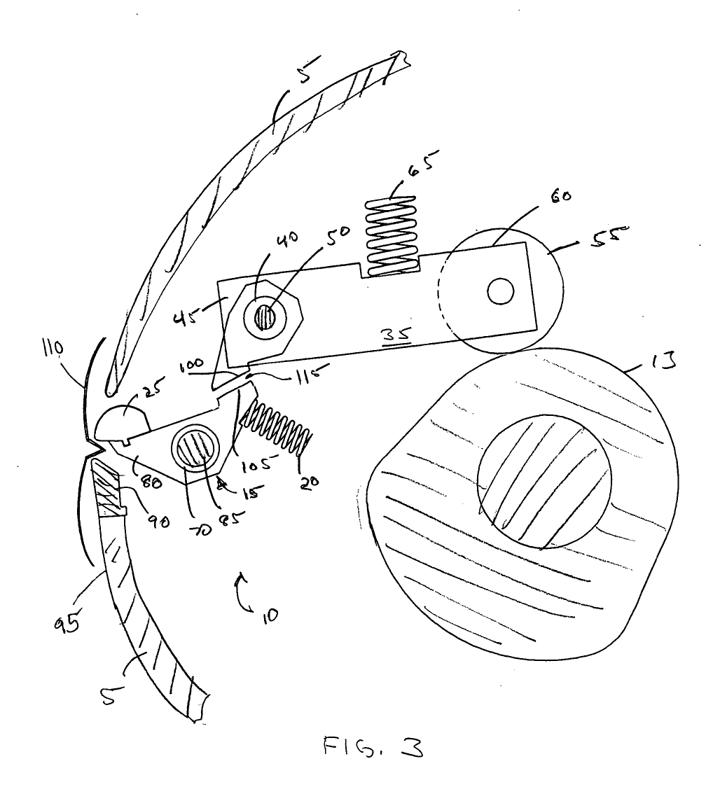

Referring to FIG. 3, as the folding cylinder 5 and gripper 10 continue to rotate about the fixed cam 13, the arm spring 65 urges the follower 55 against the cam surface as the follower rotates about the non-extended cam profile. The force of the arm spring 65 against the cam 13 causes the follower arm 35 to pivot about the arm pin 50, urging the cam follower arm contact surface 100, located at the arm's first end 45, away from the gripper member contact surface 105. With the force of the follower arm contact surface 100 removed from the gripper member contact surface 105, the member spring 20 located at the member's first end 75 causes the gripper member 15 to pivot about the member pin 85, thus urging the movable jaw 25 of the gripper member 15 towards the fixed jaw 90 of the folding cylinder 5 to hold any folded web product located between the two jaws.

When no folded material is held by the gripper 10 (FIG. 1), the movable jaw 25 of the gripper member 15 is in contact with the fixed jaw 90 of the folding cylinder 5 while the contact surfaces 100 and 105 of the cam follower arm 35 and gripper member are in contact with one another and the cam follower 55 is in contact with the cam 13. However, it is noted that the cam follower arm 35 and gripper member 15 can move independently of one another because their respective contact surfaces 100 and 105 are separate structures not attached to one another in any way. Thus, as illustrated in FIG. 3, when folded material 110 is held between the fixed and movable jaws 90 and 25, the respective contact surfaces 100 and 105 of the cam follower arm 35 and gripper member 15 may or may not be in contact with one another, with a gap 115 appearing between the surfaces when a folded material of excess thickness is held within the jaws of the gripper 10.

During the time period when any gap appears between the contact surfaces 100 and 105 of cam follower arm 35 and gripper member 15, the cam follower 55 is in continuous contact with the non-extended portion of the fixed cam 13, thus eliminating any gap from appearing between the cam follower and fixed cam (cam slap) while material of excess thickness is held within the gripper jaws. Also, because each gripper member 15 is connected independently of one another to the folding cylinder 5 via their respective bearings, the folding lane that receives material of excess thickness will not preclude other gripper members on other folding lanes from closing far enough to hold relatively thinner materials inserted therein.

In use, web-form material is deposited onto the surface of the rotating folding cylinder and tucked into the open jaws of the gripper by a tucker blade (not shown). To achieve an open position of the gripper jaws, the extended surface of the cam exerts a force against the cam follower, causing the cam follower arm to pivot about the arm pin to exert a force on the contact surface of the gripper member. The gripper member then pivots about the member pin to urge the movable jaw of the gripper member away from the fixed jaw and into the open position.

Further rotation of the folding cylinder and gripper about the fixed cam caused the cam follower to be in contact with the non-extended portion of the cam. During this time, the non-extended surface of the cam allows the cam follower arm spring to pivot the second end of the arm towards the cam and the arm contact surface at the first end of the arm away from the gripper member contact surface. The movement of the cam follower arm allows the gripper member spring to pivot the gripper member about the member pin to urge the member contact surface towards the arm contact surface and the movable jaw of the gripper member towards the fixed jaw of the cylinder surface, thus gripping the folded material therein.

1. A gripper for a for a web folding cylinder comprising:
a fixed jaw on the folding cylinder;
a cam follower arm within and rotatably connected to the folding cylinder proximal to a first end of the arm and operably connected to a cam follower at a second end of the arm, the cam follower arm second end being spring-biased towards a cam; and
a gripper member within the folding cylinder, having opposed first and second ends and a medial portion between the ends rotatably connected to the folding cylinder, the gripper member first end operably associated with the cam follower arm first end, and the gripper member a second end defining a movable jaw for operable association with the fixed jaw on the folding cylinder, the gripper member first end being spring-biased towards the cam follower arm first end.

2. The gripper of claim 1 wherein the cam follower arm and the gripper member each define an involute profile.

3. A cam-actuated web folding cylinder gripper comprising:
a fixed jaw on the folding cylinder;
an arm pivotally mounted to the folding cylinder, the arm defining an arm contact surface at a first end and a cam follower at a second end, the cam follower operably associated with and spring-biased towards a cam within the folding cylinder; and
a member within the folding cylinder, having opposed first and second ends and a medial portion between the ends, the medial portion pivotally mounted to the folding cylinder, the member defining a member contact surface at the first end operably associated with and spring-biased towards the arm contact surface and a movable gripper jaw at the second end for operable association with the fixed gripper jaw on the folding cylinder.

4. The gripper of claim 3 wherein the cam follower arm and the gripper member each define an involute profile, the involute profiles of the arm and member being in apposition to one another.
